(19) United States
(12) Patent Application Publication
(10) Pub. No.: US 2009/0176188 A1
(43) Pub. Date: Jul. 9, 2009

(54) Ablating Apparatus Particularly Useful for Removal of Dental Periapical Lesions

(75) Inventors: Idan Tobis, Givat Shmuel (IL); Joel Aschkenasy, Zurich (CH); Ronen Huber, Kadima (IL)

Correspondence Address: MARTIN D. MOYNIHAN d/b/a PRTSI, INC., P.O. BOX 16446, ARLINGTON, VA, 22215, US

(73) Assignee: Apexum Ltd., Ariel (IL)

(21) Appl. No.: 12/083,686

(22) PCT Filed: Nov. 19, 2006
(86) PCT No.: PCT/IL2006/001329

§ 371 Date: Apr. 17, 2008

Related U.S. Application Data
(60) Provisional application No. 60/737,748, filed on Nov. 18, 2005.
(60) Provisional application No. 60/737,747, filed on Nov. 18, 2005.

(51) Int. Cl. A61C 5/02

(52) U.S. Cl. 433/102

(57) ABSTRACT

Apparatus for removing a dental periapical lesion at an apex of a root canal in a tooth, includes: an ablating device sized and constructed for (a) introduction through a cavity in the tooth into the root canal; (b) movement therethrough to protrude through the apex into contact with the dental periapical lesion; and (c) rotation while in contact with the dental periapical lesion in order to remove same by ablation. In some described embodiments, the ablating device includes a sleeve and a filament moveable therein to define a protruding curved end to be brought into contact with the dental periapical lesion for ablation thereof by rotation of the filament. In another described embodiment, the ablating device includes a sleeve and a filament within the sleeve and secured at one end to one end of the sleeve, the sleeve being formed with a plurality of slits such that, displacing the sleeve towards its secured end, produces outwardly-bowed surfaces along the slits effective to ablate the dental periapical lesion tissues upon rotation of the sleeve.

### FIELD AND BACKGROUND OF THE INVENTION

The present invention relates to ablating apparatus for removing selected tissues of a person's body. The invention is particularly useful for removing dental periapical lesions, and is therefore described below with respect to this application, but it will be appreciated that the invention could be used also for removing other types of tissue, such as bone tissue, and the like.

The term “ablating” devices is used in its broadest respect, to include any form of tissue removal, e.g. by resection, cutting, grinding, filing, etc. Dental periapical lesions are lesions encompassing or surrounding the tip of the root of a tooth.

A tooth is composed of a crown and one or more roots which anchor the tooth in a jawbone. The crown, made of enamel and dentin, surrounds a pulp chamber which contains the pulp and extends to the root canal or canals. The root canal opens at the tip of the root (apex) through an opening termed “apical foramen”. A deep cavity, a cracked filling, or a cracked tooth can lead to pulp infection or injury. This in turn can lead to pulp inflammation and infection which may spread to the root canal, often causing sensitivity to hot or cold foods and pain, among other problems. If not treated at this stage the pulp may then become necrotic and infected. Bacteria that exit from the root canal through apical foramen may spread into adjacent or remote tissues. To prevent that, the host mounts an inflammatory response around the apical foramen which results in local bone destruction. The lesion thus formed is commonly termed a “periapical lesion”.

Periapical lesions may also develop when a previous root canal treatment (as detailed below) was unsuccessful in adequately performing its main task of elimination of bacteria or when prior root canal filling and/or coronal restorations are leaking, thus allowing bacteria to re-contaminate the root canal.

Treatment involves removing the diseased, injured or necrotic pulp, or contaminated root canal filling material, cleaning shaping and disinfection of the pulp chamber and root canals, followed by their sealing with a root canal filling which is followed by filling or restoring the crown. Typically, an opening into the pulp chamber is made, generally through the crown and dentine, and the pulp or necrotic/infected tissues, or the infected root canal filling material is removed using an endodontic file. The pulp chamber and root canals are then cleaned, shaped and sealed.

To prevent and/or irradicate infection , an antiseptic, such as calcium hydroxide may be applied to the pulp chamber and root canals before sealing and retained there for a period of about two weeks to disinfect them. The crown opening can be temporarily filled, e.g., with IRM, GC Fuji 9, or Ketamolar, to protect the tooth in order to prevent re-infection of the root canals until the next dental visit, and possibly in order to restore the chewing surface.

Following removal of the temporary filling and antiseptic medication, the pulp chamber and root canals are cleaned and filled with a root canal filling. A permanent filling, such as amalgam, conventional composite or a crown, are then used to restore the chewing surface of the tooth.

Alternatively, after cleaning and reshaping the root canals and applying medication, the root canals can be filled with a root filling material, such as, Gutta Percha or a paste, to an apical point of the root canal. The pulp chamber can then be filled with a temporary filling or a sealing layer. At the next dental visit, the temporary filling, as well as some of the root canal filling are removed, and a post (also referred to as a dowel) is positioned in the pulp chamber and root canal and cemented in place using a dental cement, for example, composite cement, zinc-phosphate cement, or another cement or sealer.

The post may be formed from a metal, such as a dental alloy, from quartz, reinforced carbon fibers, or from another suitable material. The post can be rigid or flexible to some extent. Where two or more root canals are being treated, one or more posts can be used.

The post can be prefabricated and shaped during the procedure. Alternatively, a mold of one of the root canals and remaining tooth and pulp chamber may be taken in the dental clinic and sent to a dental laboratory, to enable a metal cast post to be tailor-made based on the mold.

Generally, the above described treatment procedure is effected by an endodontist who removes the diseased pulp and cleans and seals the pulp chamber and root canals, a prosthodontist who fills or restores the crown, and a dental technician who prepares the restored crown based on a mold prepared by the prosthodontist. Nevertheless, all the above procedures may be, and are commonly carried out, by a dentist who is a general practitioner.

Root canal infection can also lead to formation of lesions (e.g. abscess, granuloma, or radicular cyst) around the root apex (periapical). Periapical lesions are typically treated according to the procedure described above. While such treatment is generally successful and results in healing of the periapical lesion, in cases where the root canal treatment fails, where it cannot be accessed, or where it is desired to accelerate healing, an apicoectomy surgical procedure is generally used.

Apicoectomy is a procedure in which the root tip is surgically accessed directly through the gums and the jaw bone. The granulation tissue of the periapical lesion is removed, and the root tip is resected, cleaned and sealed through any one of several approaches.

Although widely practiced, apicoectomy is an invasive surgical procedure and as such it is commonly accompanied by postoperative pain, swelling and complications. In addition, it carries a risk of infection and injury to nerves, soft tissue, bone and adjacent teeth. Furthermore, some teeth are less accessible or inaccessible surgically (e.g. palatal roots of upper molar), and as such, this procedure cannot be utilized in some periapical lesions. Finally, this procedure oftentimes results in aesthetic problems such as scarring and recession of gums around restored crown and bridgework.

As indicated earlier, while the invention is particularly useful in apparatus for removing dental periapical lesions, the invention may also be used in resection devices for removing other types of tissue.

Many different types of resection devices are known for removing tissue from a human body. Resection devices are increasingly used in minimally invasive laparoscopic or endoscopic procedures, since they allow selective separation and removal of tissue through small body openings in a very precise manner.

Typically, different procedures require different resection devices, each adapted for resection of specific tissue at a specific location. Some devices need to be repeatedly inserted and removed from the body in order to resect and remove tissue, while others incorporate or employ tissue collection mechanisms such as aspiration mechanisms.

Manual resection devices typically employ manually operated scissor-like cutting heads disposed on elongated members which terminate in levers for operating the cutting head from outside the body.

Powered tissue resection devices are typically used in, for example, arthroscopic procedures performed on knee or shoulder joints. Powered tissue resection devices used in such arthroscopic procedures are designed as elongated, hollow inner tubular member situated to cyclically move (e.g. rotate) within an elongated outer tubular member. The inner member is provided with a cutting device at its distal end, and the outer tubular member is provided with a window or other opening enabling the cutting device of the inner member to resect desired tissue presented through the outer window. During arthroscopic procedures, the joint is expanded with a fluid medium in order to provide distension and also to enhance visualization of joint tissue. The resected tissue remains suspended in the fluid, and a vacuum is applied to aspirate the resected tissue from the joint. Since such aspiration necessarily removes ambient fluid as well, continual fluid flow through the joint is required to maintain a clean, debris-free field of view.

Numerous examples of resection or ablating devices are known in the art; see for example, U.S. Pat. Nos. 5,456,689; 5,779,662; 6,632,223; 6,632,227, 6,540,747 and 6,746,451. Such devices have been used in various surgical procedures, as described for example in the above-cited U.S. Pat. Nos. 6,540,747 and 6,746,451. However, they have not heretofore been used for removing dental periapical lesions, insofar as we are aware, and therefore have not been designed for use in removing dental periapical lesions according to the present invention.

### OBJECTS AND BRIEF SUMMARY OF THE PRESENT INVENTION

One object of the present invention is to provide apparatus particularly useful for removing dental periapical lesions without cutting through the gums and the jawbone, according to the typical treatments used at the present time. Another object of the invention is to provide an ablating device which is particularly useful for removing dental periapical lesions, but which may also be used for removing other forms of tissue, e.g., for harvesting bone tissue in the treatment or prevention of bone fracture, promoting joint fusion, enhancing implant fixation, removal of diseased tissue, etc.

According to one aspect of the present invention, there is provided apparatus for removing a dental periapical lesion at an apex of a root of a tooth, comprising: a rotary ablating device sized and constructed (a) for introduction via an opening through the tooth into the root canal; (b) for movement therethrough to protrude through the apical foramen into contact with the dental periapical lesion; and (c) for rotation while in contact with the dental periapical lesion in order to remove the lesion by ablation.

The use of such apparatus for removing dental periapical lesions provides a number of important advantages over the existing removal procedure involving cutting through the gums and the jawbone of the patient. Thus, it reduces the possibility of postoperative pain, swelling and complications normally accompanying the existing procedures. In addition, it reduces the risk of infection and injury to nerves, soft tissue, bone and adjacent teeth as compared to the existing procedures. Moreover, it can be utilized virtually for all teeth, and reduces the possibility of esthetic problems, such as scarring and recession of gums, in the existing procedures.

A number of embodiments of the invention are described below for purposes of example. In some described embodiments the ablating device comprises a sleeve sized and constructed for introduction via the opening through the tooth into the root canal and for movement therethrough to the apex of the root canal; and a filament within the sleeve, of a length to protrude from the apex such as to define a curved protruding end to be brought into contact with the dental periapical lesion for ablation thereof by rotation of the filament.

According to further features in these described embodiments, the apparatus further comprises a suction device for drawing out debris produced by ablation of the dental periapical lesion. The filament may be hollow, in which case the suction device removes the debris via the hollow filament. Alternatively, the filament may be of smaller outer diameter than the inner diameter of the sleeve so as to define a space between the filament and sleeve, whereupon the suction device removes the debris via the latter space.

The curved protruding end of the filament may be of a polymeric material or of a metal. Preferably, the apparatus includes at least two such ablating devices, one including a filament of a metal capable of roughly ablating upon rotation of the filament for mincing the lesion. The other includes a filament of a polymeric material capable of further mincing the periapical lesion tissues to finer particles by ablation after the first ablating device has been used, so that the particles may be removed via the apical foramen.

According to further features, the filament may include a radio-opaque marker to allow for X-ray location thereof. Preferably, the curved protruding end of the filament constitutes 5-20% of the filament length. When the filament is of a polymer, it is preferably made of a biodegradable material.

Another embodiment of the invention is described wherein the ablating device comprises a sleeve having a proximal end and a distal end. The sleeve is sized and constructed for introduction via the cavity in the tooth into the root canal and for movement therethrough to protrude its distal one end through the apex of the root canal. The ablating device further includes a filament within the sleeve secured at its distal end to the distal end of the sleeve. The sleeve is formed with a plurality of slits at its distal end, which slits extend generally axially with respect to the longitudinal axis of the sleeve. The proximal end of the sleeve is displaceable with respect to the filament towards the distal end of the sleeve to force the distal end of the sleeve to be bowed outwardly along the slits, to thereby define a plurality of outwardly-bowed ablating surfaces effective to remove the dental periapical lesion upon rotation of the sleeve.

According to further features in this described embodiment, the proximal end of the sleeve is formed with an axially-extending slot, and the proximal end of the filament is formed with a pin received in the latter slot for guiding the displacement of the sleeve with respect to the filament to produce the outwardly-bowed ablating surfaces. Preferably, the slits extend angularly with respect to the longitudinal axis of the sleeve such that the produced outwardly-bowed surfaces of the sleeve extend angularly with respect to the longitudinal axis of the sleeve.

As will be described more particularly below, such an ablating device can also be used for resecting other tissue, e.g. for harvesting bone tissue and the like.

Further features and advantages of the invention will be apparent from the description below.

### BRIEF DESCRIPTION OF THE DRAWINGS

The invention is herein described, by way of example only, with reference to the accompanying drawings, wherein:

FIGS. 1 and 2 illustrate two forms of ablating devices constructed in accordance with the present invention;

FIGS. 3a-3m illustrate various stages in one procedure involving the use of the ablating device of FIG. 1 for removing a dental periapical lesion;

FIG. 4a illustrates a modification in the metal filament ablating device of FIG. 1;

FIGS. 4b and 4c are side elevational views, and FIG. 4d is a top plan view, of the ablating device of FIG. 4a;

FIG. 5 illustrates another polymer-filament ablating device constructed in accordance with the present invention;

FIGS. 6a-6d are views, corresponding to those of FIGS. 4a-4d, illustrating another metal-filament ablating device constructed in accordance with the invention;

FIG. 7 illustrates the manner in which the ablating device of FIGS. 6a-6d is used for removing a dental periapical lesion;

FIG. 8 illustrates a protective cover used in one step of another procedure as illustrated in FIGS. 10a-10k;

FIG. 9 illustrates the manner in which the protective cover of FIG. 8 is used in the procedure of FIGS. 10a-10k;

FIGS. . 10a-1Ok illustrate various stages in another procedure involving the use of both ablating devices for removing a dental periapical lesion;

FIGS. 11a and 11b illustrate another construction of ablating device in accordance with the present invention in the initial and operative conditions of the ablating device;

FIG. 12 illustrates apparatus including the ablating device of FIGS. 11a and 11b; and

FIG. 13 illustrates the apparatus of FIG. 12 used in harvesting bone tissue from a hip bone or the like.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

As indicated earlier, the present invention provides apparatus particularly useful for removing dental periapical lesions at an apex of a root of a tooth. For this purpose, the apparatus provides a rotatable ablating device sized and constructed for (a) introduction through a cavity in the tooth into the root canal; (b) movement therethrough to protrude through the apical foramen into contact with the dental periapical lesion; and (c) rotation while in contact with the dental periapical lesion in order to mince the lesion by ablation so that the particles may be removed via the apical foramen.

While the invention is particularly useful for removing dental periapical lesions, it can also be used in a wide range of laparoscopic procedures, as well as less invasive subcutaneous and endoscopic procedures. The terms “laparoscopic” and “endoscopic” are interchangeably used herein to refer to surgical procedures performed through small, natural or artificially created openings or portals in the body (e.g. arthroscopic, endoscopic, laparoscopic, hysteroscopic, thoracoscopic). The apparatus of the present invention may be used in such procedures in conjunction with a camera or other imaging devices (e.g. X-ray, MRI, ultrasound) which enables the physician to view the work site during the procedure.

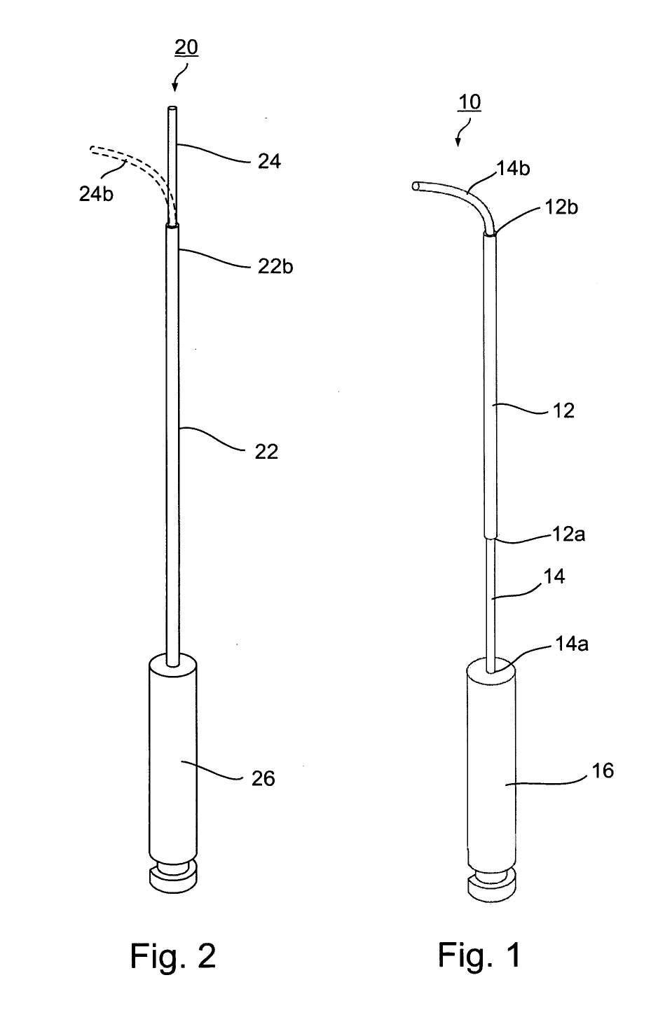

FIG. 1 illustrates one form of rotatable ablating device particularly useful in apparatus constructed in accordance with the present invention for removing dental periapical lesions. The ablating device 10 illustrated in FIG. 1 includes a sleeve 12 sized and constructed for introduction via a cavity in the tooth (e.g., a cavity drilled through the crown of the tooth) into the tooth root canal, and for movement therethrough to the apex of the root canal, as will be described more particularly below. Sleeve 12 includes a proximal end 12a and a distal end 12b. The latter end is to be located at the apex of the root canal having the dental periapical lesion to be removed.

The ablating device illustrated in FIG. 1 further includes a filament 14, also having a proximal end 14a and a distal end 14b. As shown in FIG. 1, distal end 14b of filament 14 protrudes outwardly of distal end 12b of sleeve 12. Its protruding end is formed with a curvature, curving away from the longitudinal axis of the filament and of the sleeve. As will be described more particularly below, the protruding outwardly-curved end 14b of filament 14 is brought into contact with the dental periapical lesion to be removed such that rotation of the filament ablates the dental periapical lesion.

The proximal end 14a of filament 14 is fixed to a shank 16 which may have an annular recess 18 to facilitate coupling the filament to a rotary drive, or be coupled using friction. In the ablating device illustrated in FIG. 1, filament 14 is rotatable and axially-displaceable with respect to sleeve 12.

Sleeve 12 is fabricated from a polymer, such Nylon, Pebax or Teflon, or a metal, such as stainless steel or a super elastic alloy, such as superelastic NiTinol™. Preferably, it has a length of about 12-40 mm, an external diameter of about 0.25-0.9 mm, and an internal diameter of about 0.20-0.80 mm.

It will be appreciated that although sleeve 12 is illustrated as having a single lumen, a configuration having two or more separate lumens may also be used. Such a multi-lumen sleeve configuration can be used for aspiration, drug delivery, or fiber optic imaging. The sleeve may also have scales for measuring the depth of penetration, and an anchoring mechanism (e.g. screw tip, oxidized section) for anchoring sleeve 12 to a tissue (e.g. bone).

Filament 14 may also be fabricated from a polymer, such as Poly-p-dioxanone, polylactyc acid or polyglycolic acid, or an alloy such as shape memory alloy Nitinol™. It preferably has a length of about 25-50 mm, and an external diameter of about 0.25-0.80 mm. Filament 14 can be solid or hollow; if hollow, an internal diameter of about 0.1-0.7 mm is preferred. Filament 14 may be fabricated from a radio-opaque material, but if not, at least one radio-opaque marker can be added to the filament at equal intervals to allow for X-ray location.

The outwardly-curved end portion 14b of filament 14 is typically 5-20% of the filament length. It may be fabricated from the same material as the remainder of the filament, or from a different material (e.g. different hardness, elasticity, etc). Since end portion 14b is mechanically stressed by the rotary motion and by contact with body tissue, if fabricated from a polymer it is preferably fabricated from a biocompatible or bioresorbable polymer such that any fragments resulting from its disintegration are resorbed by the body.

End portion 14b can be fabricated in a round, square, triangular, flat, star or any other cross-sectional shape suitable for tissue resection or grinding. This end portion is preferably designed to angle or form a predetermined shape where protruding from the sleeve distal end 12b when positioned within the body. This can be achieved by fabricating filament 14, or portion 14b thereof, from a shape memory polymer or alloy (e.g. Nitinol™) which is straight at room temperature and angles to produce a curved portion 14b when placed under temperatures higher than its transformation temperature (e.g. body temperature). If it is a superelastic alloy of Nitinol, it can be forced to a straight shape by the sleeve, when inserted into it.

As indicated earlier, filament 14 in the ablating device illustrated in FIG. 1 is both rotatably and axially displaceable with respect to sleeve 12. FIG. 2 illustrates an ablating device, therein generally designated 20, also including a sleeve 22 enclosing a filament 24, with the distal end 24b of the filament projecting from the distal end 22b of the sleeve. In this case, however, both the filament 24 and the sleeve 22 are secured to adaptor 26, such that both the sleeve and filament rotate together with the adaptor. In fabricating such an ablating device, the filament 24 may be passed through the sleeve 22 until the distal end 24b of the filament projects through the distal end 22b of the sleeve to produce the desired curved end portion of the filament, and then the adaptor 26 may be crimped to bind the sleeve and filament to the adaptor, such that the sleeve rotates with the filament.

The FIG. 2 construction is particularly useful where both the filament and the sleeve are made of a polymer. The constructions and dimensions of the protruding end 24b of the filament may be such that it assumes the curved configuration (shown in broken lines in FIG. 2) by centrifugal force upon the rotation of the filament.

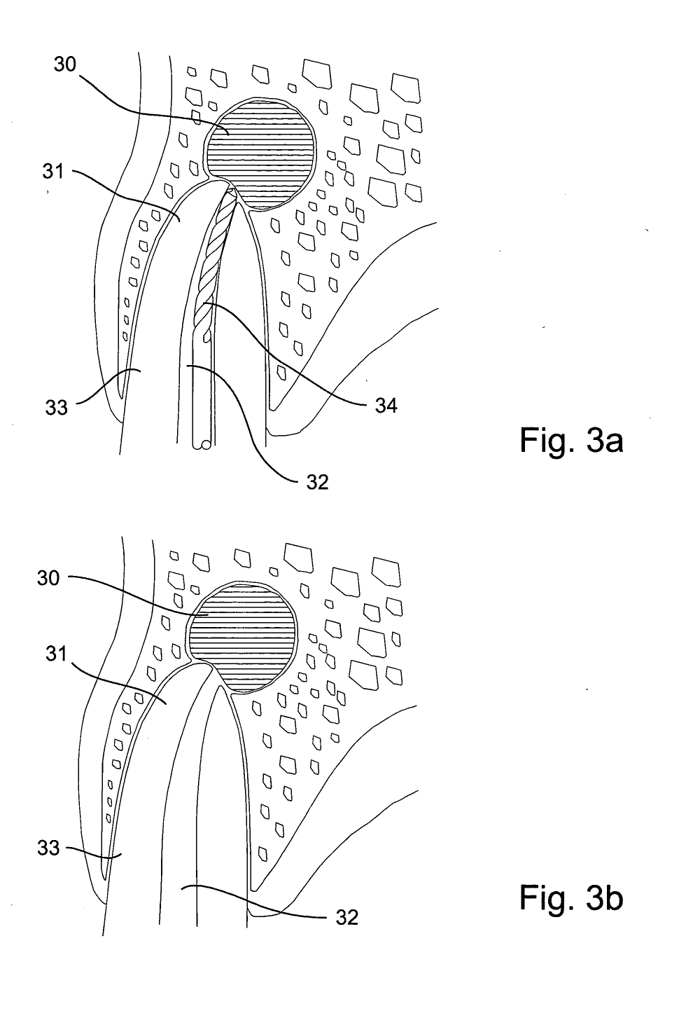

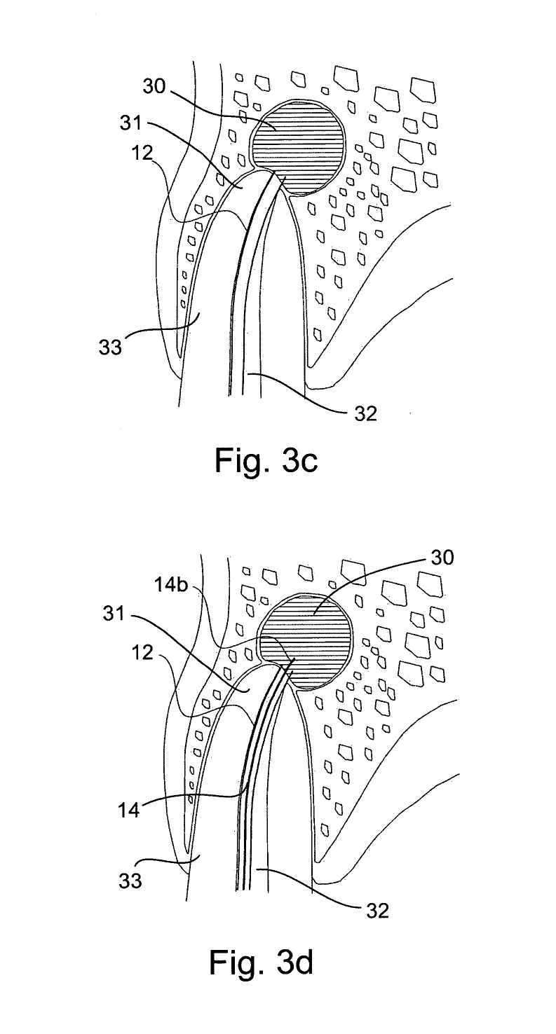

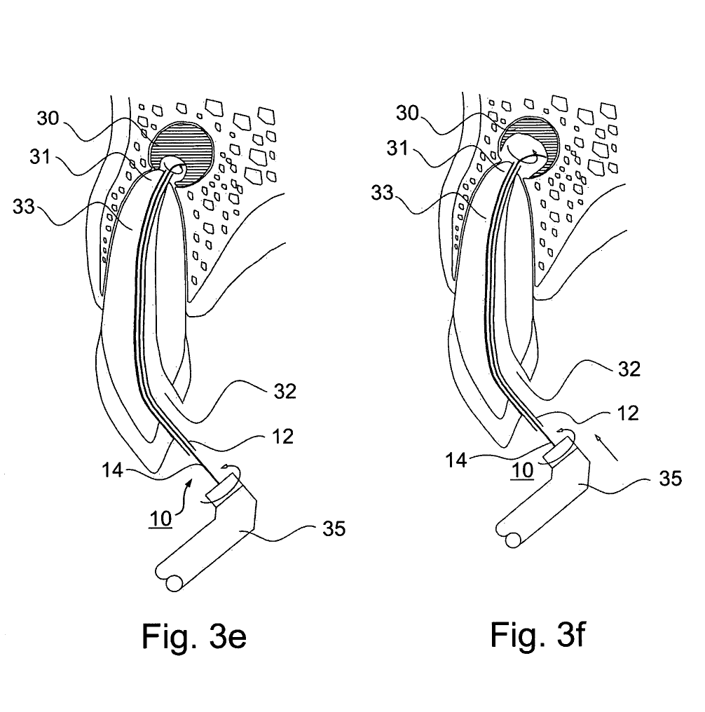

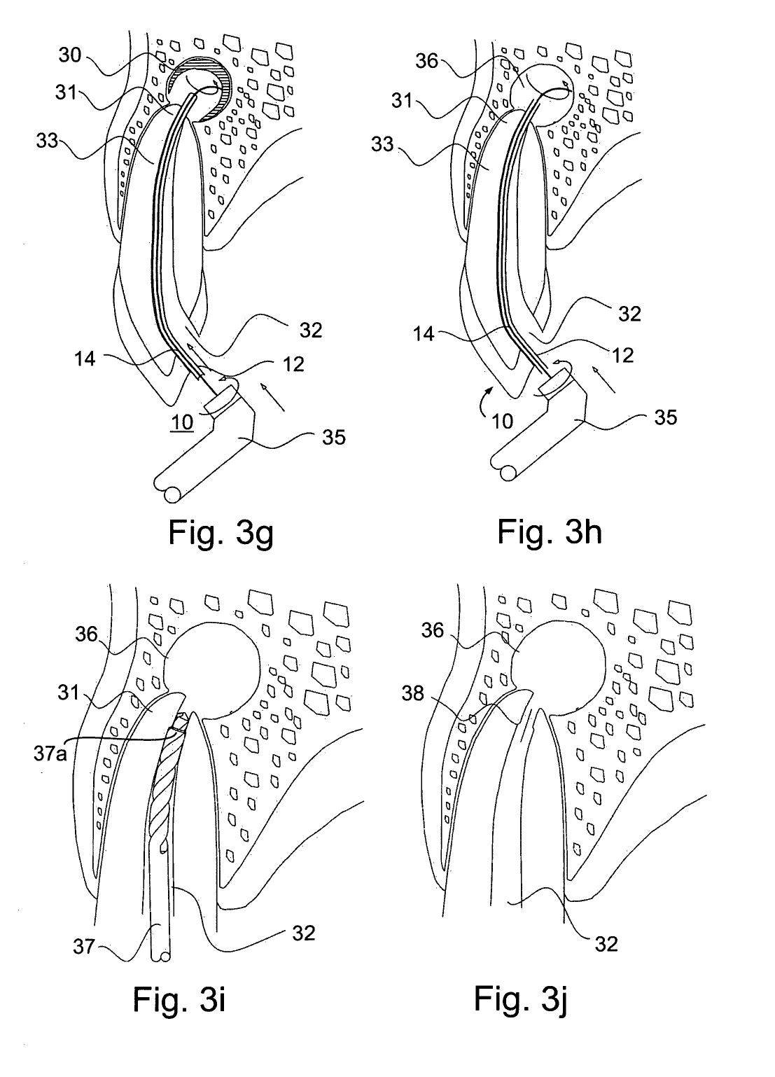

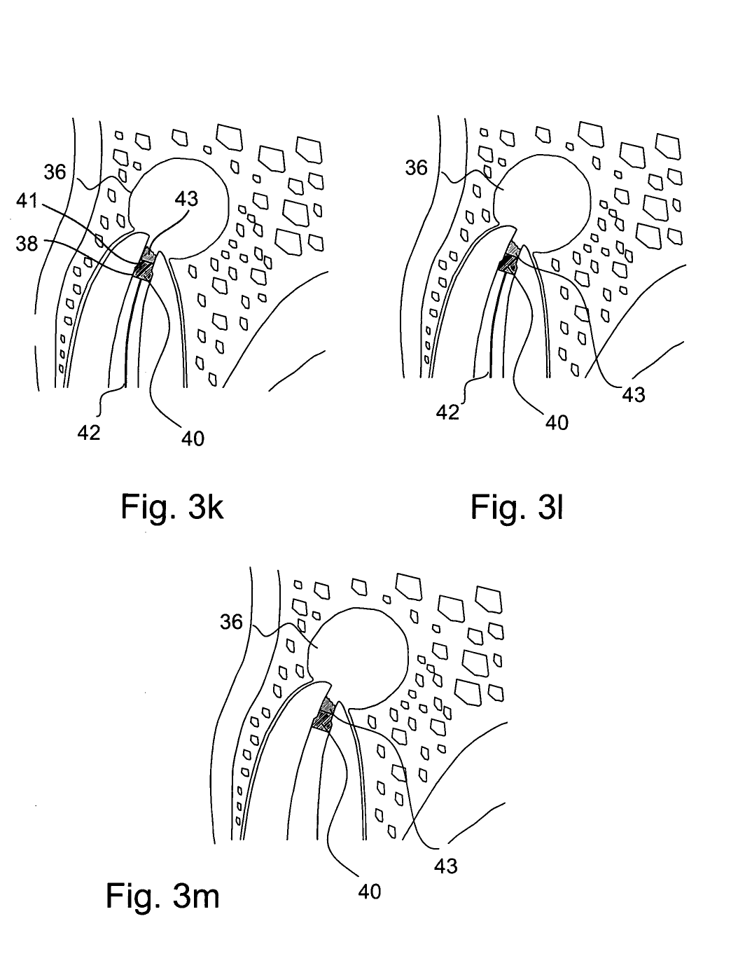

FIGS. 3a-3m illustrate one manner of using the ablating device 10 of FIG. 1 (or 20 of FIG. 2) for the removal of a dental periapical lesion, schematically illustrated at 30 in those figures, located at the apex 31a of a canal 32 formed in a tooth root 33.

Following a standard pulp chamber access and pulp removal, or removal of infected root canal filling material from a prior failing treatment, the root canal is cleansed using files and liquid to remove all traces of pulp debris, bacteria or root canal filling material and the like. The apical foramen of root canal 32 is then reshaped and enlarged , using a file 34 to an ISO size of 40-120 (0.4-1.2 mm), preferably size 60 (0.6 mm), as shown in FIGS. 3a, 3b.

Following reshaping of the apicalyend of the root canal 32, the ablating device 10 of FIG. 1 is then utilized for lesion removal. Sleeve 12 is first inserted into the reshaped root canal 32 to a working length (end of apex 31a), and filament 14 is then inserted through sleeve and into lesion 30, such that distal end portion 14b of the filament protrudes from the distal end of sleeve 12 (FIGS. 3c, 3d).

When utilized for apical lesion removal, sleeve 12 and filament 14 can be fabricated from a polymer or a metal (e.g. polymers such as nylon, PGA, PLA, or metal alloys such as Nitinol™). Filament 14 may have any desired cross sectional shape (e.g., round, elliptical, flat, star-like, etc). If round, it preferably has a typical cross sectional diameter of 0.1-0.5 mm and a length of 20-40 mm. Filament 14 can be solid or hollow and selected of any suitable Shore hardness (typically Shore hardness range A 10-90). A hollow configuration is preferred in cases where provision of medication, such as a local anesthetic or a rinsing fluid, is required, although such rinsing or medication provision, as well as suction, can also be effected through a lumen in sleeve 12, or through a space formed between sleeve 12 and filament 14.

The ablating device 10 is then connected to an electrical or pneumatic drill head (dental handpiece) 35 (FIG. 3e), e.g. KAVO GentleSilence 8000, KAVO intramatic E or Morita triautozx. Filament 14 is rotated within sleeve 12, first at a low speed (several hundred rpm) to enable initial ablation of granulation tissue surrounding the root apex 31a (FIG. 3e). The rotational speed of filament 14 is then gradually increased (up to 50,000 rpm), and both filament and sleeve are advanced (FIGS. 3e-3h) in the direction of the lesion with an in-and-out motion, to enable three dimensional fine grinding of the tissues of the surrounding lesion 30.

Throughout the procedure, a liquid such as water or saline solution may be utilized to wash the ground tissue, to assist in grinding, and to prevent overheating. Rinsing and suction can be conducted through filament 14, if hollow: alternatively filament 14 can be periodically removed, and rinsing/suction can be conducted through the sleeve. As a still further alternative, rinsing/suction can be conducted through a space between sleeve 12 and filament 14.

To enable three dimensional grinding and complete removal of lesion 30, the ablating device utilizes a filament 14 which angles when protruding through its sleeve 12. Such angling can be controlled by the amount of filament protruding from the sleeve and by the rotational speed used. Alternatively, the filament, or at least its end portion, can be made of a material (e.g., Nitinol™) which is capable of angling, and/or of forming a shape such as a hook or loop when the end portion protrudes from sleeve 12.

The root's apical portion 31a (FIG. 3h) can also be resected or ablated by using a filament 14 having a blade-like end portion 14b which curves back to form a hook once it protrudes from sleeve 12. Rotating this blade against apical portion 31 will grind it off and thus remove side canals which are a potential source of infection. Such root apex resection tends to improve healing and to reduce the chances of reinfection.

During or following the above-described ablation procedure, an X-ray procedure can be used, by the addition of a radio-opaque guide positioned on filament 14 or injected therethrough, to provide the dentist with information regarding the size of the periapical lesion and the extent of its removal. It can also provide a reference point for monitoring the healing phase.

In any case, once lesion 30 and surrounding tissue are removed, the ablation device is removed, the lesion space and root canal are thoroughly rinsed and the root canal 32 is sealed (e.g. by using gutta percha and cement), and the crown is restored. The procedure may be carried out as a one-visit procedure or as a multiple-visit one. In case of a one-visit procedure all the above steps may be carried out. In case of a multi-visit procedure the initial stage of cleaning, shaping and disinfection of the infected root canal or removal of prior root canal filling, may be carried out in the first visit, followed by placement of a medicament (e.g. an antiseptic or inflammatory response modifier) in the root canal to be retained there until the second visit, when the periapical ablation procedure will be carried out, followed by a root canal filling.

As another alternative, after lesion 30 and surrounding tissue have been removed, various substances may be injected into the periapical space 36 (FIG. 3h) through the sleeve 12 or hollow filament 14, in order to disinfect the region and accelerate bone growth/regeneration.

In this example, after lesion 30 with its tissue has been removed, a drill 37 (FIG. 3i), formed with a step or shoulder 37a is utilized to create a step or shoulder shown in FIG. 3j at 38 approximately 1 mm from the tip. This reshaping is effected such that the canal preferably tapers in a stepwise fashion towards the root apex 31.

A prefabricated plug 40 having a shoulder 41a (FIGS. 3k-3m) is then positioned via a guide 42 against shoulder 38. Plug 40 can be composed of mineral trioxide aggregate (MTA), Titanium, Nitinol™, gutta percha, composite material, girconium, or any combination thereof and may be cemented therein, as shown at 43 (FIG. 31). Following plug positioning and its permanent cementation, guide 42 may be detached from plug 40 (FIG. 3m), and the root canal 32 is then obturated via conventional methods.

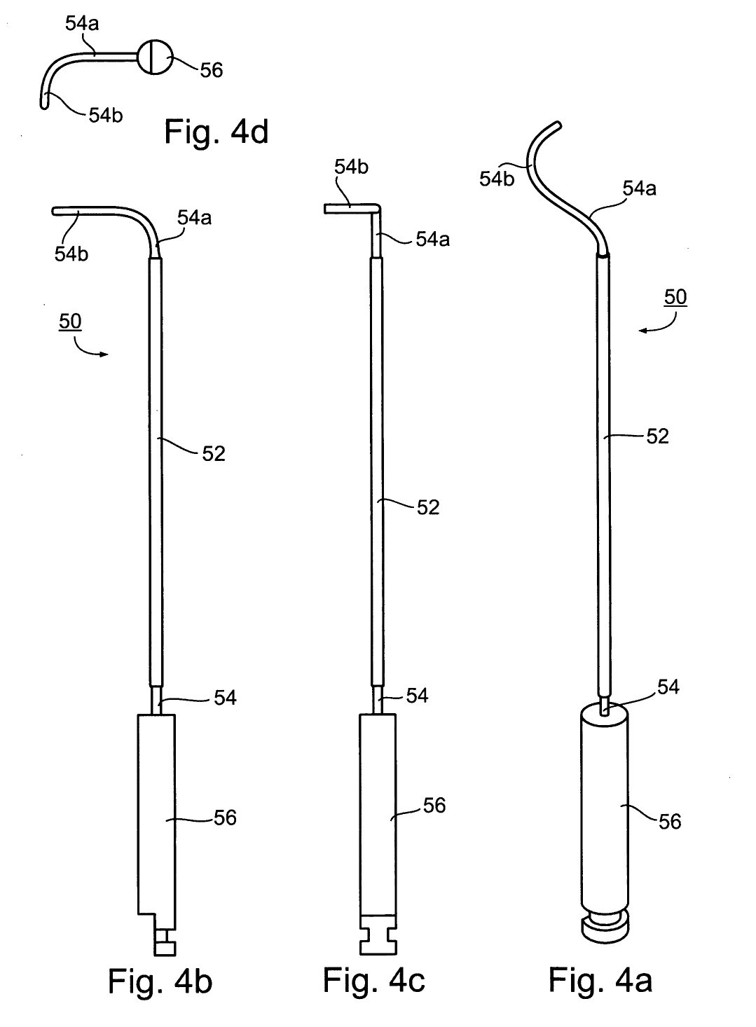

The above-described procedure illustrates the use of a single ablating device, such as 10 of FIG. 1 or 20 of FIG. 2, for removing a dental periapical lesion at the apex of a root of a tooth. FIGS. 4a-10k illustrate the use of two such ablating devices in a two-step procedure for removing a dental periapical lesion at the apex of a root of a tooth, or for other applications involving removing or resecting tissue enclosed within a harder tissue, typically a diseased/infected/inflamed bone tissue enclosed within a healthy bone tissue, without damaging the surrounding tissue.

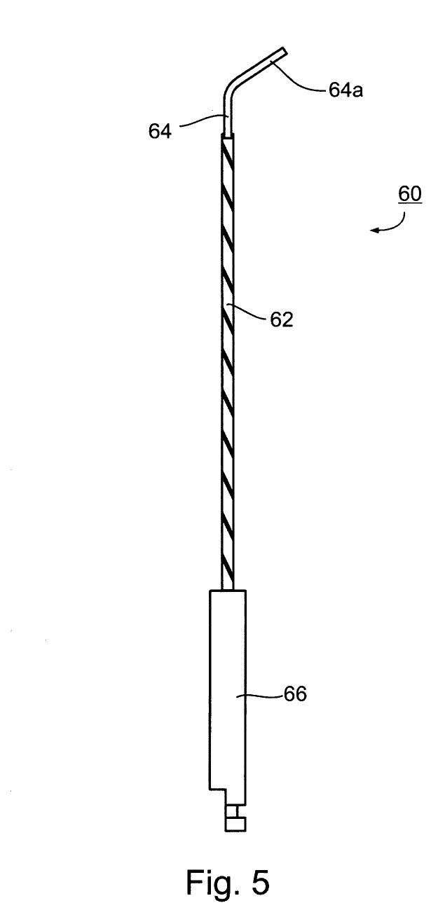

Such a procedure is performed in two consecutive steps: the first step utilizes an ablating device, such as shown at 50 in FIGS. 4a-4d, including a Nitinol superelastic sleeve or sheath 52 enclosing a shape-memory or superelastic Nitinol filament 54; and the second step utilizes an ablating device, as shown at 60 in FIG. 5, including a superelastic Nitinol sleeve or sheath 62 enclosing a filament 64 of an elastic biocompatible or bioresorbable polymer, such as poly-dioxanone, polyglycolic acid or polyactyc acid.

In ablating device 50 (FIGS. 4a-4d) used in the first step, the shape memory Nitinol filament 54 is fixed to the shank 56 connectable to the rotary drive (e.g., 35, FIG. 3e), whereas the superelastic Nitinol sleeve 52 is freely mounted on filament 54 for axial and rotatable movement with respect thereto. The shape memory Nitinol filament 54 has a transformation temperature slightly lower than body temperature (typically 25° C.). When filament 54 is extended out of the constricting sleeve 52 and exposed to body temperature, its distal end assumes a predetermined shape comprising two arcs 54a, 54b which lie on planes orthogonal, or at an angle to each other and to the longitudinal axis of sleeve 52. alternatively, the filament may be constructed of a high elasticity or super elasticity material such as super elastic Nitinol ™, which is constricted at a straight shape by the sleeve, and accepts its pre-determined shape when release from the sleeve. Filament 54 is preferably of circular cross-section, with a blunt end facing a relatively sharp outer edge. The arcs have a radius of between 0.56 mm for various sizes of lesions.

In the first step, the sleeve 52 and the projecting end of the filament 54 are rotated at low to medium speeds, of up to 1000 rpm (typically 30-1000 rpm). This assures that while the projecting end of the filament is extended into the inflamed soft tissue, the sharp edge is pushed forward to allow easy penetration. However, when the filament is fully extended and rotated clockwise, the distal bend 54b presents a blunt edge which is deflected from the hard bone tissue, thereby assuring that the healthy bone tissue is not damaged during the rotation. Ablating device of FIGS. 4a-4d is used in the first step to remove the inflamed tissue and/or to grind or mince the periapical lesion, before utilizing the ablating device 60, including the polymer filament 64, to be inserted for use in the second step in which the lesion is removed.

In ablating device 60 used in the second step of the treatment, both the polymer filament 64, and its sleeve 62, are attached to the adapter 66 so that both rotate together. In this case, ablating device 60 is rotated at a higher speed, over 1,000 rpm (typically 14,000-50,000 rpm). At such speed, the centrifugal forces acting on filament 64 cause it to deflect sideways. Since the polymer filament 64 is relatively soft, it cannot penetrate the inflamed tissue. However, after the tissue has been initially ground by ablating device 50 (FIGS. 4a-4d) utilizing the Nitinol filament 54, the tissue is soft and fragmented enough to allow the penetration of filament 64 of ablating device 60 when the filament is rotated at high speed. Filament 64 thus minces the already ground tissue to very fine particles that may be washed and suctioned out through the apical foramen, as described above. Filament 64 is biocompatible or bioresorbable, which ensures that when the filament wears and tears as a result of brushing against the hard bone tissue, the resulting filament particles will be resorbed by the body in a matter of a few weeks.

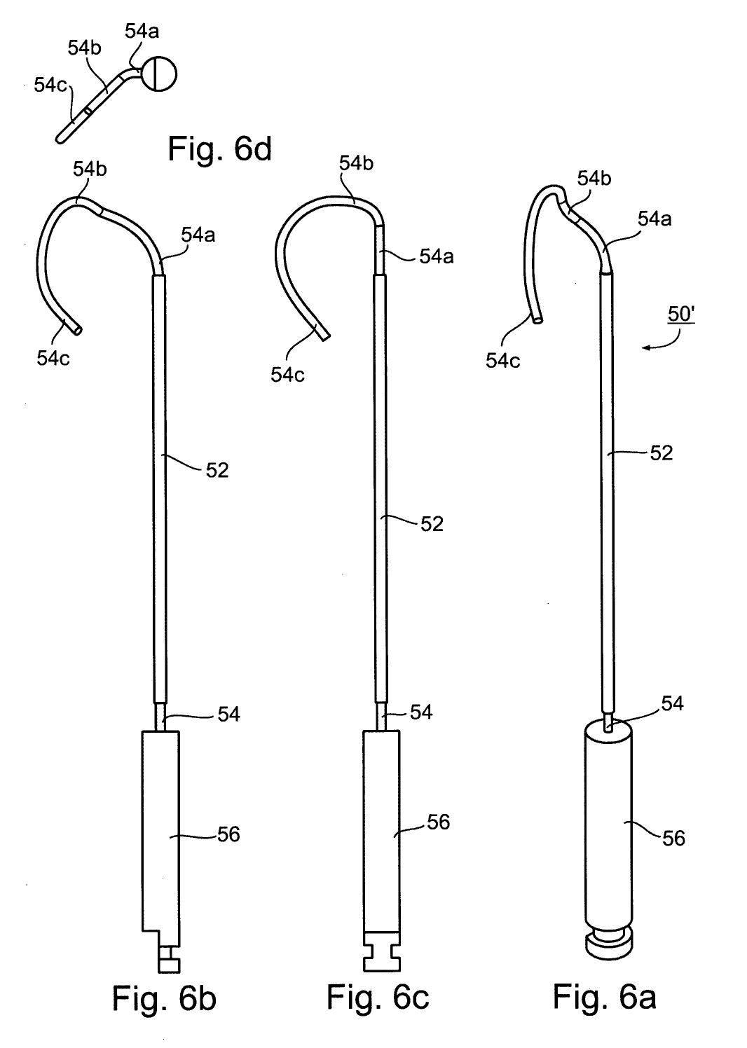

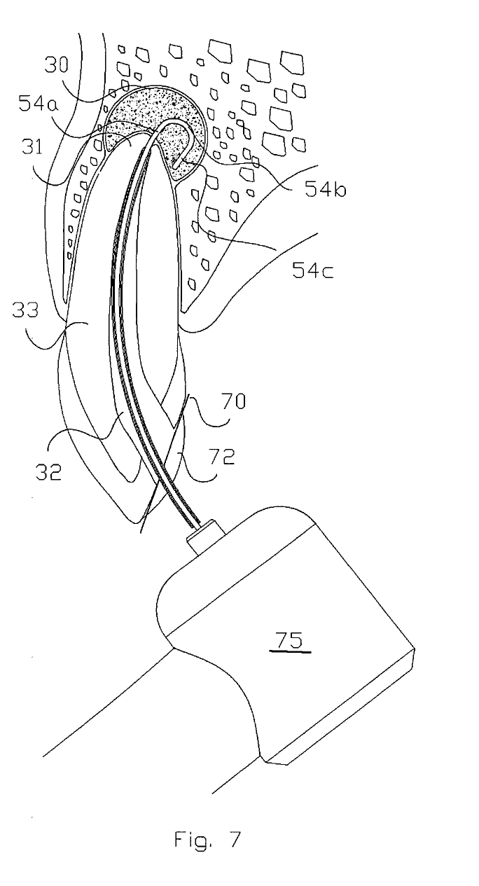

FIGS. 6a-6d illustrate an ablating device, generally designated 50′, of basically the same construction as ablating device 50 of FIGS. 4a-4d, and therefore corresponding parts are identified by the same reference numerals. In ablating device 50′ of FIGS. 6a-6d, however, the Nitinol filament 54 has a third curved section 54c at its distal end, which is of a retrograde configuration, i.e., bent back towards its proximal end. Such a retrograde section of the filament allows reaching parts of the region that surround the tooth apex and which may otherwise be inaccessible to the ablator, as shown in FIG. 7.

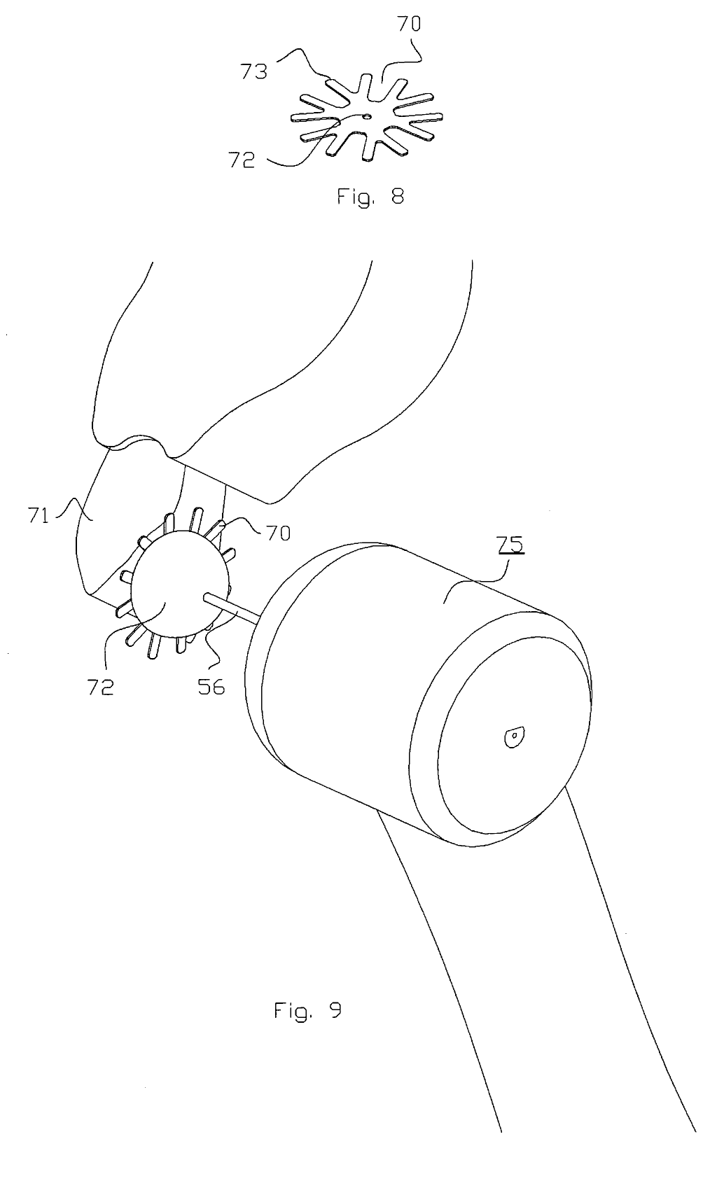

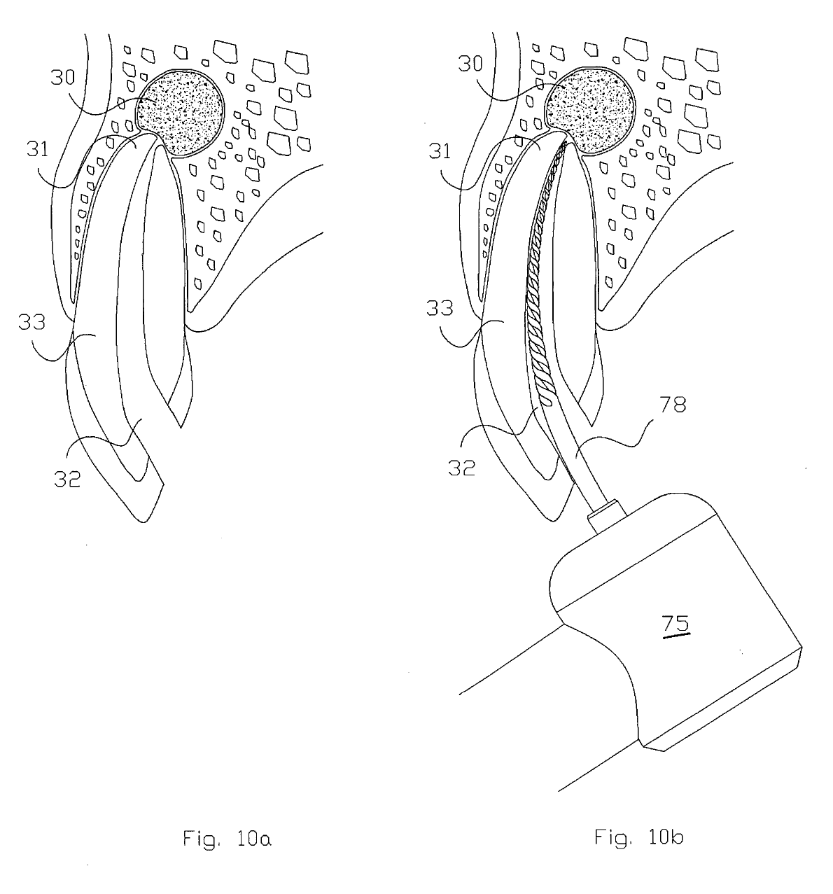

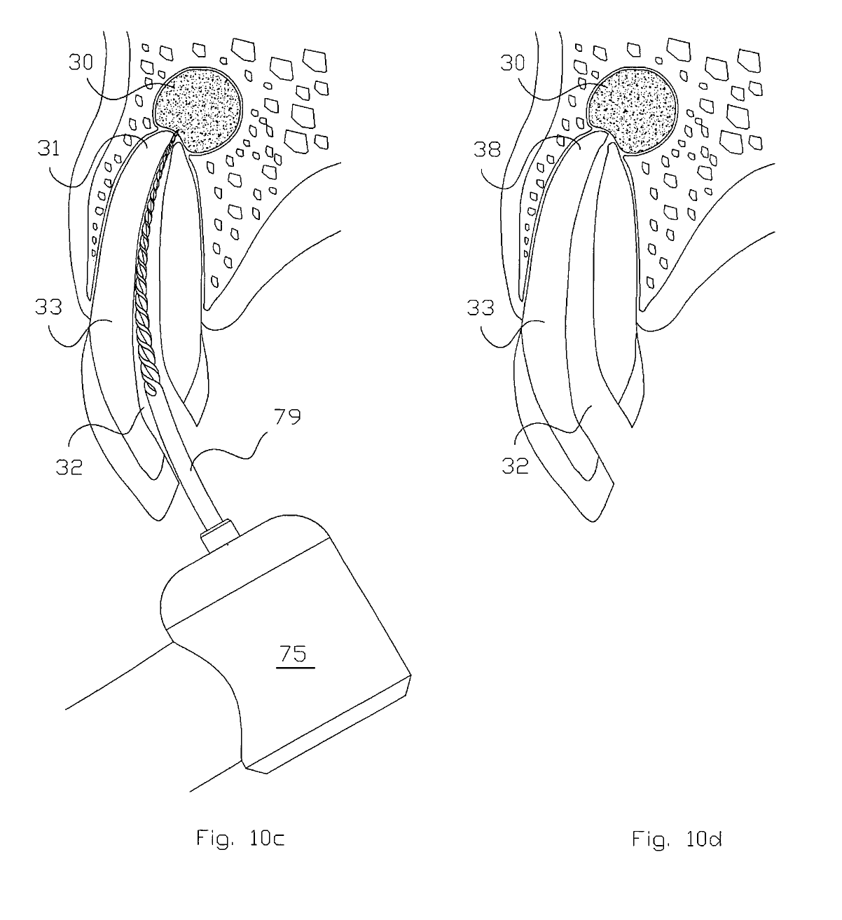

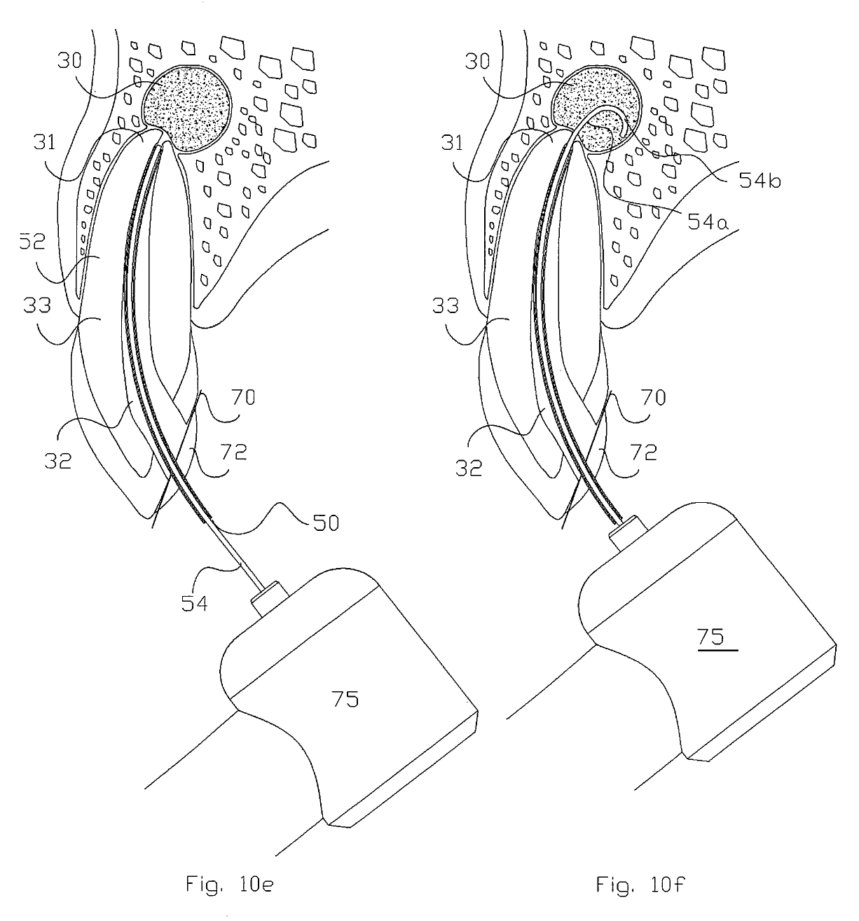

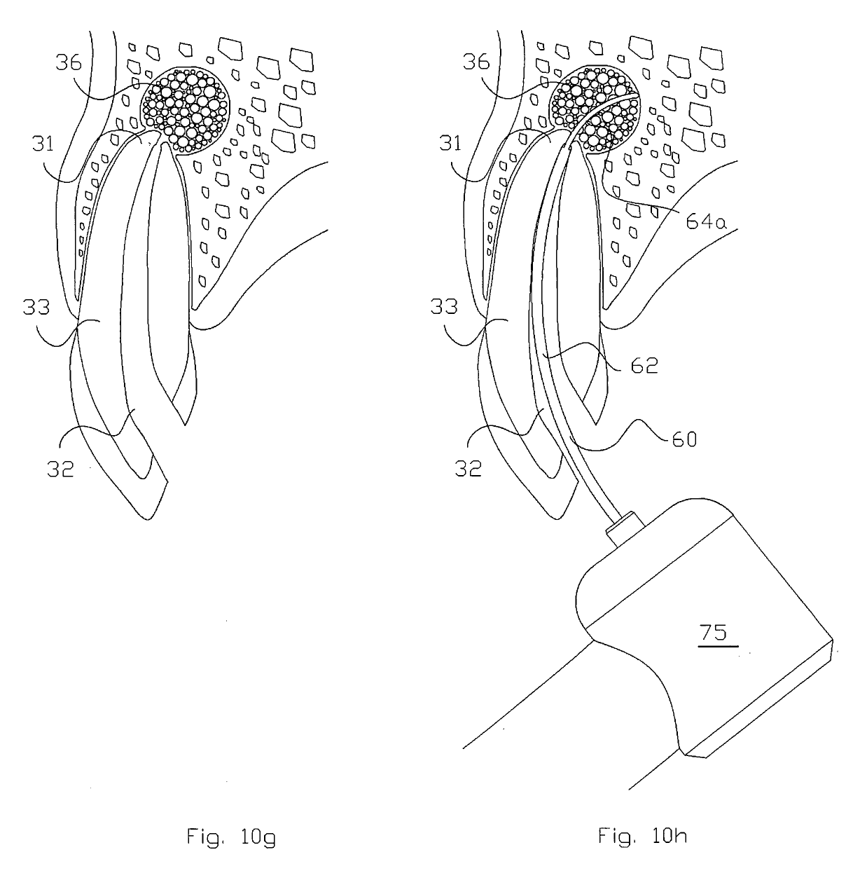

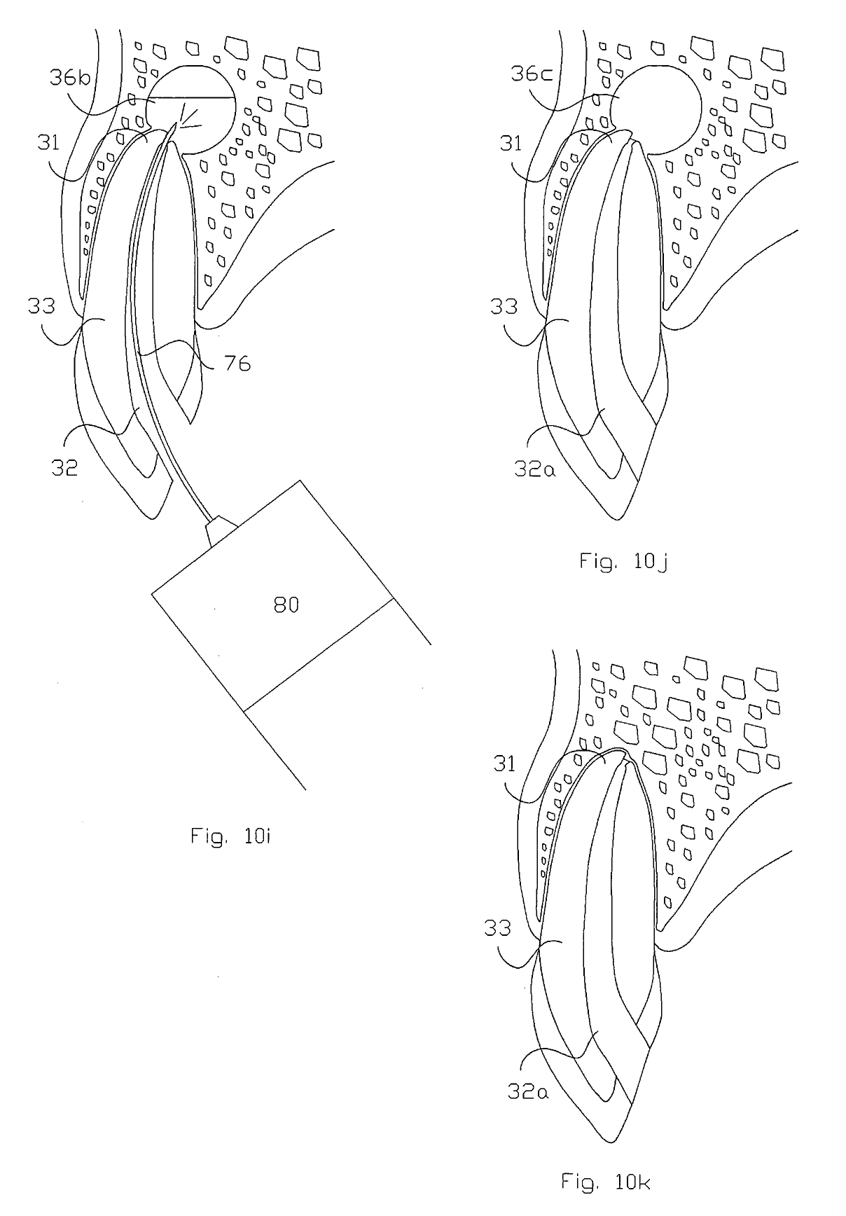

As will be described more particularly below, ablating 50 (or 50′), including the Nitinol filament 54, is used in the first step. When used in the first step, its sleeve 52 is fixed by an adhesive to the tooth and stabilized, before the Nitinol filament 54 is rotated by its adaptor 56. To prevent the adhesive from entering the root canal, a protective cover is used, such as shown at 70 in FIG. 8. Such a protective cover may be made of thin aluminum foil to be placed over the crown of the tooth (71, FIG. 9) to be treated, after an opening has been formed through the crown to provide access to the root canal. The ablating device 50 (or 50′), with the Nitinol filament 54 completely retracted within the sleeve 52, is passed through opening 72 in the protective cover 70 into the root canal of the tooth, and is moved through the root canal to its position at the apex of the root canal. A glob of adhesive 74 is then applied over the protective cover 70 and the sleeve (FIG. 9), such that the adhesive flows between the tabs 73, and thereby binds the protective cover and the sleeve to the tooth. Such an arrangement has been found to firmly hold the sleeve 52 of the ablating device to the tooth, allowing the filament 54 to be advanced through the sleeve into contact with the periapical lesion to be removed, without clogging the root canal by the adhesive.

FIGS. 10a-10k illustrate an example of a procedure that may be used, utilizing the metal-filament ablating device 50 of FIGS. 4a-4d (or 50′, of FIGS. 6a-6d), and the polymer-filament ablating device 60 of FIG. 5, for removing a dental periapical lesion in accordance with the present invention. The protective cover 70, described above with respect to FIGS. 8 and 9, is used in the first step of this procedure with the metal-filament ablating device 50 (or 50′) to fix the outer sleeve 52 to the tooth, before deploying the metal filament 54.

1. The root canal 32 of the treated tooth is endodontically prepared by a No. 45K file 78 , to a working length 0.5 mm short of the apical foramen 31. This may preferably be done using a rotary LightSpeed file No. 45. (FIG. 10b) Patency should be established using a No. 25K to 30K file 79 (FIG. 10c). the resulting shape of the apical foramen is stepwise shoulder 38 (FIG. 10d)

2. After rinsing and drying the root canal, ablating device 50 (or 50′), with its Nitinol working filament 54 still contained and hidden within the Nitinol sleeve 52, is inserted to the working length (FIG. 10e).

3. The sleeve is fixed to the tooth and stabilized by placing a protective cover 70 (FIG. 8) over the tooth 71 (FIG. 9), to cover the opening previously formed through its crown leading to the root canal to be treated, and applying a glob of adhesive 74 over the outer surface of the protective cover and the sleeve. A viscous adhesive, such as glass ionomer composite, is used such that it assumes a semi-spherical shape, having a thickness of 1-2 mm at its center, and flows by surface tension in spaces between the radiating tabs 73. The adhesive used may be a settable dental adhesive, e.g., settable by ultraviolet light (FIG. 10e). As indicated earlier, such an arrangement fixes the sheath of the ablating device to the tooth without danger of clogging the root canal with the adhesive.

4. The Nitinol filament 54 is then attached to the speed-controlled contra-angle handpiece 75.

5. While holding the handpiece gently, the user pushes the Nitinol filament 54 through the stabilized sleeve 52 and through the apical foramen into the periapical lesion 30 (FIG. 10f). When the distal curved ends 52a, 52b of Nitinol filament 52 are out of the sleeve, the filament is easily moved back and forth, allowing the operator to know it has emerged from its sleeve.

6. The filament 54 is rotated at a speed of 200-300 rpm while the filament is moved with in and out movements of 1-2 mm, for 30-60 seconds. The extent of the in and out movements can be judged from the distance between the coronal end of the sleeve and the handpiece. A rubber stopper placed on the rotating part may help this judgment.

7. The filament is retracted through the sleeve, and the coronal fixation is then gently removed by breaking off the adhesive, and removing the protective cover from the tooth and the ablating device 50 out of the root canal (FIG. 10g).

8. The root canal may then be rinsed with saline solution or distilled water using a small diameter (30-gauge or thinner) needle, inserted through the apex, such that some of the debris is flushed out with the back-flow.

9. Ablating device 60 (FIGS. 5a-5d) is then measured and its polymer filament 64 is cut to the proper length. Its curved protruding end 64a should be 1-3 mm longer than the estimated diameter of the treated periapical lesion 30.

10. Ablating device 60 is then attached to the handpiece and gently inserted into the root canal, until its metal sleeve 62 reaches the apical stop, while its polymer filament 64 slides through the apical foramen and into the roughly minced periapical lesion 36a (FIG. 10h).

11. Ablating device 60 is then rotated at 15,000-50,000 rpm, for 20-60 seconds, with slight in and out motion, and then taken out of the root canal.

12. The finely minced content of the periapical crypt 36b is then rinsed out with copious amounts of normal saline solution or distilled water, using a 30-32 G needle 76 attached to a syringe 80 (FIG. 10i).

13. The root canal is then dried, using paper points (FIG. 10j), followed by root canal obturation 32a (FIG. 10j).

14. Within several months (2-6), the bone around the bony crypt grows into the empty space 36c, resulting in full recovery (FIG. 10k).

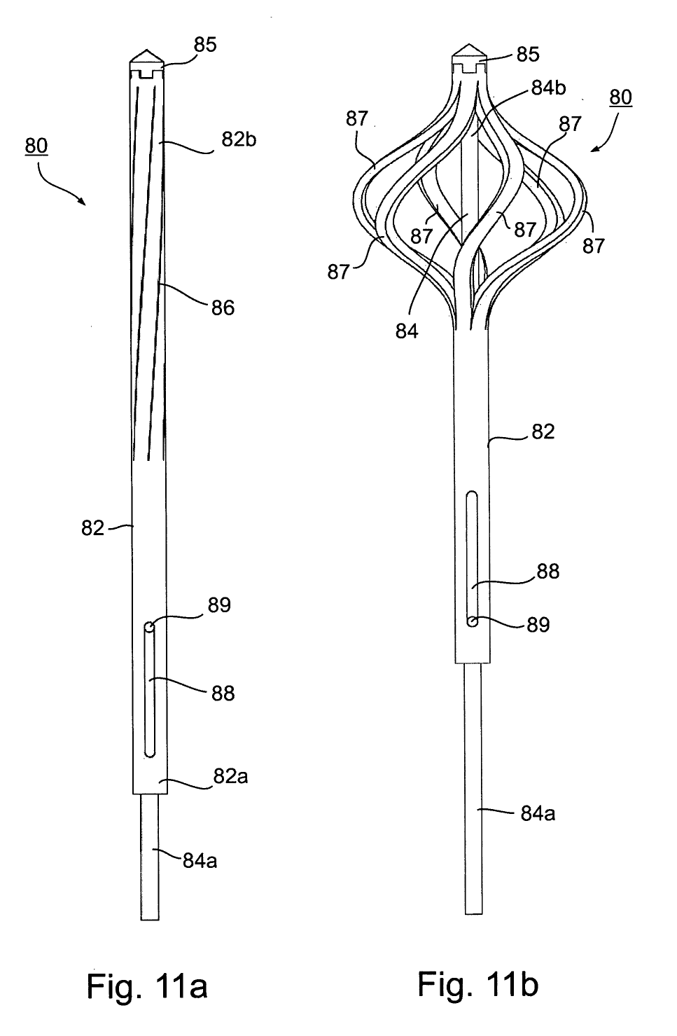

FIGS. 11a and 11b illustrate another construction of ablating device in accordance with the present invention. The ablating device illustrated in FIGS. 1a and 11b, and therein generally designated 80, also includes a sleeve 82 having a proximal end 82a and a distal end 82b, and a filament 84 within the sleeve and also having a proximal end 84a and a distal end 84b. In this case, however, the distal end 84b of filament 84 is secured to the distal end 82b of the sleeve 82, as shown at 85. In addition, the distal end of sleeve 82 is formed with a plurality of slits 86 extending generally axially, and preferably slightly angularly, with respect to the longitudinal axis of the sleeve (FIG. 11a). The proximal end 82a of the sleeve is displaceable towards its distal end 82b and the distal end 84b of the filament fixed thereto. This forces the distal end 82b of the sleeve to be bowed outwardly along the slits 86 to thereby define a plurality of outwardly-bowed strips or surfaces 87 effective, upon rotation of the sleeve, to ablate a substance with which the ablating surfaces 87 are in contact (FIG. 11b).

In addition, the proximal end 82a of sleeve 82 is formed with a longitudinally-extending slot 88, and the proximal end 84a of filament 84 is formed with a pin 89 received in slot 88 for guiding the displacement of the sleeve with respect to the filament to produce the outwardly-bowed ablating surfaces 87.

Ablating device 80 illustrated in FIGS. 1 la and 1 lb can also be constructed, as described above, for removing a dental periapical lesion at an apex of a root canal in a tooth. Thus, sleeve 82 may be constructed such that, in its original condition illustrated in FIG. 11, it may be introduced via an opening through the tooth, into the root canal and moved therethrough, and through the apex of the root canal, into contact with the dental periapical lesion. Sleeve 82 may then be displaced towards its distal end fixed at 85 to filament 84, to thereby force the distal end of the sleeve to be bowed outwardly along the slits 86, and to define the plurality of outwardly-bowed strips or surfaces 87, shown in FIG. 11b, effective to ablate the dental periapical lesion when the sleeve is rotated.

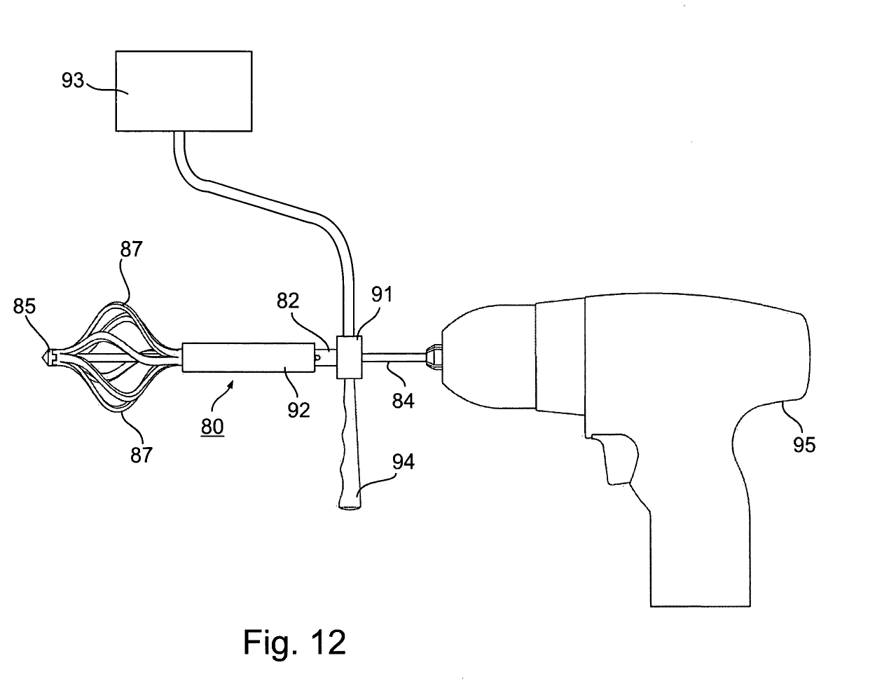

FIG. 12 more particularly illustrates the overall apparatus using ablating device 80 for removing tissue, e.g. a dental periapical lesion, in the manner described above.

Thus, as shown in FIG. 12, the overall apparatus includes a rotary drive unit 95 which is coupled to filament 84 to rotate the filament, and thereby also to rotate sleeve 82 via a coupling device, rotatably mounted within a fixture 91, coupling these two elements. The illustrated apparatus further includes an outer sleeve 92 rotatably receiving the rotatable elements 82, 84 of the ablating device 80 so as to serve as a guide or hand grip for the ablating device.

As shown in FIG. 12, the apparatus further includes an aspirator 93 or other suction device coupled to the ablating device 80 via fixture 91 for drawing-out the debris and/or for rinsing the ablated region. Fixture 91 may also be provided with a handle 94 to facilitate holding and manipulating the ablating device. In this case, both the sleeve 82 and filament 84 are connected to the rotary drive 95. The outwardly-bowed distal end of the sleeve define the ablating surfaces 87 which ablate the tissue.

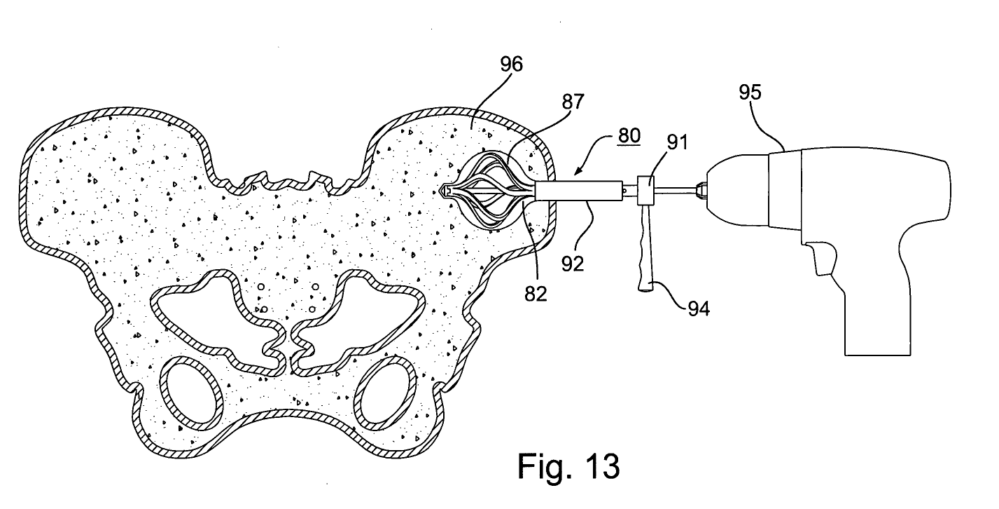

The apparatus illustrated in FIG. 12 can also be used in bone harvesting and collection procedures, e.g., for harvesting bone tissue from a hip bone as illustrated in FIG. 13. Prior to harvesting, an operator inserts a 2 mm guide wire (Synthes 292.65) into the iliac crest 3 cm lateral to the ASIS, and drills over the guide wire with a 4.5 cannulated drill (Synthes 310.69) to a depth of 1 cm.

The operator then inserts sleeve 92 which serves as a working channel. In this configuration of the ablator device 80, sleeve 92 has an outer diameter of 4.5 mm, a screw tip with a positive stop, and an inner cannulated trocar having an outer diameter of 3.2 mm and an inner diameter of 2 mm.

Sleeve 92 is secured to hip bone 96 via the screw tip, and the trocar is removed. Sleeve 82 of the ablator device 80 is then inserted through sleeve 92 and connected to drill head 95.

In this configuration of the ablator device, sleeve 82 is designed as a semi-flexible shaft having a cutting portion (i.e., the ablating elements 87 of sleeve 82) which will not penetrate the thin cortical bone but will mince spongy bone material.

The rotational speed (RPM), and also the configuration of the ablating elements 87, are selected such that thin cortex is not damaged, and the temperature of minced tissues does not rise above 42° C. This ensures that cells and bony trabeculi of the harvested bone material do not suffer any thermal or mechanical damage. A typical cutting speed is preferable, is selected from a range of 500 to 800 rpm.

The ablating elements 87 are preferably configured such that during cutting, the generated bone and tissue fragments are evacuated from the site of cutting. For example, in the configuration of FIGS. 11a, 11b, the reverse spirals of the ablating elements 87 facilitate bone and tissue fragment evacuation.

Collection of bone/tissue material (paste) can be effected through hollow sleeve 92. The bone paste collected can be stored in a sterile container attached to the aspirator.

While the invention has been described above with respect to several preferred embodiments, it will be appreciated that these are set forth merely for purposes of example, and that many other variations, modifications and applications of the invention may be made.

What is claimed is:

1. Apparatus for removing a dental periapical lesion at an apex of a root canal of a tooth, comprising: a rotary ablating device sized and constructed for (a) introduction via an opening through the tooth into the root canal; (b) movement therethrough to protrude through the apical foramen into contact with the dental periapical lesion; and (c) rotation while in contact with said dental periapical lesion in order to remove the lesion by ablation.

2. The apparatus according to claim 1, wherein said rotary ablating device comprises:
a sleeve sized and constructed for introduction via said opening through the tooth into said root canal and for movement therethrough to said apical end of the root canal;
and a filament within said sleeve of a length to protrude from said apex such as to define a curved protruding end to be brought into contact with the dental periapical lesion tissues for ablation thereof by rotation of the filament.

3. The apparatus according to claim 2, wherein said filament is axially moveable with respect to said sleeve.

4. The apparatus according to claim 2, wherein said filament is rotatable with respect to said sleeve.

5. The apparatus according to claim 2, wherein said filament is rotatable with said sleeve.

6. The apparatus according to claim 2, wherein said apparatus further comprises a suction device for drawing out debris produced by ablation of the dental periapical lesion.

7. The apparatus according to claim 6, wherein said filament is hollow, and said suction device removes said debris via said hollow filament.

8. The apparatus according to claim 6, wherein said filament is of smaller outer diameter than the inner diameter of said sleeve so as to define a space between said sleeve and filament, and wherein said suction device removes said debris via said space.

9. The apparatus according to claim 2, wherein said curved protruding end of the filament is of a polymeric material capable of removing said dental periapical lesion by ablation upon rotation of the filament.

10. The apparatus according to claim 2, wherein said curved protruding end of the filament is of a metal capable of reshaping said apex of the root canal by ablation upon rotation of the filament.

11. The apparatus according to claim 2, wherein said apparatus comprises at least two of said ablating devices, one including a filament of a metal, and the other including a filament of a polymeric material.

12. The apparatus according to claim 2, wherein said filament includes a radio-opaque marker to allow for X-ray location thereof.

13. The apparatus according to claim 2, wherein said curved protruding end of the filament constitutes 5-20% of the filament length.

14. The apparatus according to claim 2, wherein said filament is made of a biodegradable polymeric material.

15. The apparatus according to claim 1, wherein said ablating device comprises:
a sleeve having a proximal end and a distal end, said sleeve being sized and constructed for introduction via said opening in the tooth into said root canal and for movement therethrough to protrude its distal end through said apex of the root canal;
and a filament within said sleeve and having a distal end secured to the distal end of said sleeve;
said sleeve being formed with a plurality of slits at said distal end, which slits extend generally axially with respect to the longitudinal axis of the sleeve;
the proximal end of the sleeve being displaceable with respect to said filament towards said distal end of the sleeve to force the distal end of the sleeve to be bowed outwardly along said slits, to thereby define a plurality of outwardly-bowed ablating surfaces effective to remove the dental periapical lesion upon rotation of the sleeve.

16. The apparatus according to claim 15, wherein the proximal end of the sleeve is formed with an axially extending slot; and wherein the proximal end of said filament is formed with a pin received in said slot for guiding the displacement of said sleeve with respect to said filament to produce said outwardly-bowed ablating surfaces.

17. The apparatus according to claim 15, wherein said slits extend angularly with respect to the longitudinal axis of said sleeve such that the produced outwardly-bowed surfaces of the sleeve extend angularly with respect to the longitudinal axis of the sleeve.

18. An ablating device, comprising:
a sleeve having a proximal end and a distal end;
and a filament disposed within said sleeve and also having a proximal end and a distal end;
the distal end of said filament being secured to the distal end of said sleeve;
the distal end of said sleeve being formed with a plurality of slits extending generally axially with respect to the longitudinal axis of the sleeve;
the proximal end of the sleeve being displaceable towards the distal end of the sleeve to force the distal end of the sleeve to be bowed outwardly along said slits, to thereby define a plurality of outwardly-bowed surfaces effective, upon rotation of the sleeve, to ablate a substance with which said ablating surfaces are in contact.

19. The ablating device according to claim 18, wherein the proximal end of the sleeve is formed with an axially-extending slot; and the proximal end of said filament is formed with a pin received in said slot for guiding the displacement of said sleeve with respect to said filament to produce said outwardly-bowed ablating surfaces.

20. The ablating device according to claim 18, wherein said slits extend angularly with respect to the longitudinal axis of the sleeve such that the produced outwardly-bowed surfaces of the sleeve extend angularly of the longitudinal axis of the sleeve.
